(19) United States
(12) Patent Application Publication
(10) Pub. No.: US 2001/0013388 A1
(43) Pub. Date: Aug. 16, 2001

(54) Laminated ceramic electronic part and method for manufacturing thesame

(75) Inventors: Takaharu Miyazaki, Nagaokayo-shi (JP); Tsuyoshi Yamana, Nagaokakyo-shi (JP); Yukio Hamaji, Nagaokakyo-shi (JP)

Correspondence Address: OSTROLENK FABER GERB & SOFFEN, 1180 AVENUE OF THE AMERICAS, NEW YORK, NY, 100368403

(73) Assignee: Murata Manufacturing Co., Ltd.

(21) Appl. No.: 09/776,127

(22) Filed: Feb. 2, 2001

(30) Foreign Application Priority Data
Feb. 3, 2000 (JP) 2000-025979

(51) Int. Cl. C04B 37/00

(52) U.S. Cl. 156/89.12

(57) ABSTRACT

A laminated ceramic electronic part such as a multilayer ceramic capacitor having a long mean life and an excellent reliability can be provided, even when the thicknesses of the ceramic layers are about 3 μm or less. For that purpose, the arithmetic mean roughness (Ra) of the interfaces between the internal electrodes and the ceramic layers is made to be about 200 nm or less, and the area rate of pores in a cross-sectional area of the ceramic layers is made to be about 1% or less. Preferably, the arithmetic mean roughness (Ra) of the surface of a ceramic green sheet used for obtaining the ceramic layers is made to be about 100 nm or less, and the internal electrodes are composed of metal films formed by a thin film forming method.

This is a continuation-in-part of application Ser. No. 09/699,550, filed Oct. 30, 2000.

### BACKGROUND OF THE INVENTION

1. Field of the Invention

The present invention relates to a laminated ceramic electronic part such as a multilayer ceramic capacitor, and a manufacturing method therefor, for example.

More specifically, the present invention relates to improvements for realizing thinner ceramic layers and thinner internal electrodes.

2. Description of the Related Art

Conventionally, ceramic dielectric materials such as barium titanate, strontium titanate and calcium titanate which have a perovskite structure are widely used for a material of a capacitor by virtue of their high dielectric constants. From another viewpoint, large capacitance as well as miniaturization is requested for a capacitor as a passive component, in accordance with the movement toward miniaturization of electronic parts in recent years.

On the other hand, it was necessary to bake a multilayer ceramic capacitor using a ceramic dielectric for its dielectric layers in the air at a temperature of as high as 1,300° C. or so. Therefore, a precious metal such as palladium and platinum, or an alloy thereof, has been used for the internal electrodes. However, these materials for the electrodes were very expensive. Accordingly, the cost of the material for the electrodes occupied a large percentage in the production cost, making it difficult to reduce the production cost.

To solve the above-described problem, progress has been made in using a base metal as a material for the internal electrodes of a multilayer ceramic capacitor, and various ceramic dielectric materials have been developed in consideration of the reduction resistance to allow baking in a neutral or reductive atmosphere, least the electrodes be oxidized during the baking. As a base metal material for the internal electrodes of this type, enumerated are cobalt, nickel, copper, etc. From the viewpoint of cost and oxidation resistance, nickel is mainly used.

At present, further miniaturization as well as larger capacitance is requested for a multilayer ceramic capacitor. To meet this request, development of a ceramic dielectric material with a higher dielectric constant and realization of thinner ceramic layers comprising a ceramic dielectric are being investigated. At the same time, realization of thinner electrodes is also being investigated.

Making the ceramic layers located between the internal electrodes thinner is the most effective means for improving the capacitance of a multilayer ceramic capacitor. However, when the thickness of a ceramic layer is 3 μm or less, for example, a problem will occur that the life of a multilayer ceramic capacitor falls off, as the unevenness of the interface between a ceramic layer and an internal electrode becomes larger, and the number of pores (voids) in the ceramic layer is increased.

Accordingly, it is necessary to make the unevenness of the interface between a ceramic layer and an internal electrode smaller, or to make flat each of the surfaces of a ceramic green sheet to be used for the ceramic layers and of an electroconductive paste film to be used for the internal electrodes, before lamination and baking. For that purposes, it is conceivable to make smaller particle sizes of a ceramic raw material powder contained in the ceramic green sheet and of a metal powder contained in the electroconductive paste film, respectively, as described in Japanese Unexamined Patent Application Publication No. 10-223469.

However, when particle sizes of a ceramic raw material powder and of a metal power become smaller, both of the powders tend to aggregate and show a lower level of dispersion, in general. Thus, there is a limit in taking measures only by applying smaller particle size.

Furthermore, there is a problem in that the dielectric constant is lowered as the particle size of a ceramic raw material powder is made smaller. This will make it difficult to realize larger capacitance. Also, as the particle size of a metal powder for use in the internal electrodes is made smaller, the sintering initiation temperature of the power is decreased, tending to generate delamination. This makes it difficult to use a metal powder as a material for a multilayer ceramic capacitor.

Furthermore, as described, for example, in Japanese Unexamined Patent Application Publication No. 60-83314, 1-42809, 1-226139, or 6-232000, there is a method in which metal films are used as the internal electrodes in order to realize thinner ceramic layers. However, even though internal electrodes comprising such metal films are used, unevenness of the interfaces between ceramic green sheets and internal electrodes becomes large when the ceramic green sheets are laminated, incurring a shortened life of a multilayer ceramic capacitor, if the unevenness of the surface of the ceramic green sheet is large.

### SUMMARY OF THE INVENTION

Accordingly, it is one of the objects of the present invention to provide a technology for making it possible to realize thinner internal electrodes and thinner ceramic layers without structural defects, in a laminated ceramic electronic part such as a multilayer ceramic capacitor, and to provide a small-size laminated ceramic electronic part which has a high performance such as large capacitance, with a high reliability.

The present invention also provides a method for manufacturing the laminated ceramic electronic part as described above.

The present invention is directed to a laminated ceramic electronic part having a laminated body comprising a plurality of laminated ceramic layers obtained by sintering a ceramic raw material powder, and internal electrodes located along particular interfaces between these ceramic layers, wherein the arithmetic mean roughness (Ra) of the interfaces between the internal electrodes and the ceramic layers is about 200 nm or less, and the area rate of pores in a cross-sectional area of the ceramic layers is about 1% or less for the purpose of solving the above-described technical problems.

When the above-described ceramic layers are obtained by baking a ceramic green sheet comprising a ceramic raw material powder, the arithmetic mean roughness (Ra) of the surface of this ceramic green sheet is preferably about 100 nm or less.

A ceramic green sheet that has such a surface roughness as described above, can be preferably obtained by applying compression/flattening treatment onto the surface.

Also, in the present invention, the internal electrodes are preferably formed by a thin film forming method. As the thin film forming method, vapor deposition, sputtering or plating can be applied, for example.

Also, the present invention is applied especially advantageously when the thicknesses of the ceramic layers contacting the internal electrodes are about 3 μm or less.

Also, the present invention is applied especially advantageously to a multilayer ceramic capacitor further comprising external electrodes formed on each of the edge surfaces of the laminated body facing each other, wherein the ceramic layers comprise a ceramic dielectric, and a plurality of internal electrodes are formed in such a way that an edge of each of them is exposed on either of the edge surfaces so as to be electrically connected to one of the external electrodes.

The present invention is also directed to a method for manufacturing the laminated ceramic electronic part as described above.

A method for manufacturing the laminated ceramic electronic part according to the present invention comprises the steps of: forming a metal film to be used for an internal electrode on a support having a flat surface; forming a ceramic green sheet comprising a ceramic raw material powder over the support so as to cover the metal film; subjecting the surface of the ceramic green sheet facing outward to compression/flattening treatment so that the surface has an arithmetic mean roughness (Ra) of about 100 nm or less; obtaining an unbaked laminated body by laminating a plurality of ceramic green sheets including the ceramic green sheet that has been peeled off the support and holds the metal film; and baking the unbaked laminated body.

Another method for manufacturing the laminated ceramic electronic part according to the present invention comprises the steps of: forming a ceramic green sheet comprising a ceramic raw material powder on a first support having a flat surface; subjecting the surface of the ceramic green sheet facing outward to compression/flattening treatment so that the surface has an arithmetic mean roughness (Ra) of about 100 nm or less; forming a metal film to be used for an internal electrode on a second support having a flat surface; transferring the metal film from the second support onto the surface of the ceramic green sheet facing outward; obtaining an unbaked laminated body by laminating a plurality of ceramic green sheets including the ceramic green sheet that has been peeled off the first support and holds the metal film; and baking the unbaked laminated body.

In the method for manufacturing a laminated ceramic electronic part according to the present invention, it is preferable, for example, to apply a thin film forming method such as vapor deposition, sputtering or plating as a means for forming the metal film.

### BRIEF DESCRIPTION OF THE DRAWINGS

FIG. 1 is a cross-sectional view showing a multilayer ceramic capacitor 1 according to an embodiment of the present invention;

FIGS. 2A to 2C are illustrative cross-sectional views showing the process steps implemented for manufacturing the multilayer ceramic capacitor 1 as shown in FIG. 1 in a preferred embodiment according to the present invention; and

FIGS. 3A to 3E are illustrative cross-sectional views showing the process steps implemented for manufacturing the multilayer ceramic capacitor 1 as shown in FIG. 1 in another preferred embodiment according to the present invention.

### DESCRIPTION OF THE PREFERRED EMBODIMENTS

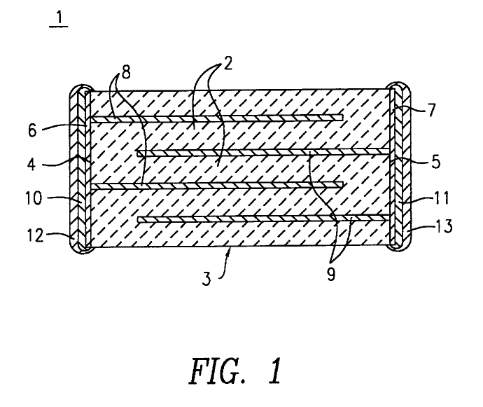

The following is an explanation on an embodiment wherein the present invention is applied to a multilayer ceramic capacitor 1 having a structure as shown in FIG. 1.

With reference to FIG. 1, the multilayer ceramic capacitor 1 comprises a laminated body 3 having ceramic layers 2 made of a plurality of laminated dielectric ceramics as well as a first external electrode 6 and a second external electrode 7, each formed on a first edge surface 4 and a second edge surface 5 of the laminated body 3.

The multilayer ceramic capacitor 1 constitutes a rectangular-shaped chip-type electronic part as a whole.

A first group of internal electrodes 8 and a second group of internal electrodes 9 are placed in an alternate manner inside the laminated body 3. The internal electrodes 8 of the first group are formed along a plurality of particular interfaces between the ceramic layers 2, with each of their edges exposed on the first edge surface 4, so that they are electrically connected to the first external electrode 6.

The internal electrodes 9 of the second group are formed along a plurality of particular interfaces between the ceramic layers 2, with each of their edges exposed on the second edge surface 5, so that they are electrically connected to the second external electrode 7.

Furthermore, the external electrodes 6 and 7 are, as necessary, coated with plating layers 10 and 11 comprising Ni, Cu, a Ni—Cu alloy or the like, respectively. Furthermore, second plating layers 12 and 13 comprising solder, tin or the like may be formed over these plating layers 10 and 11.

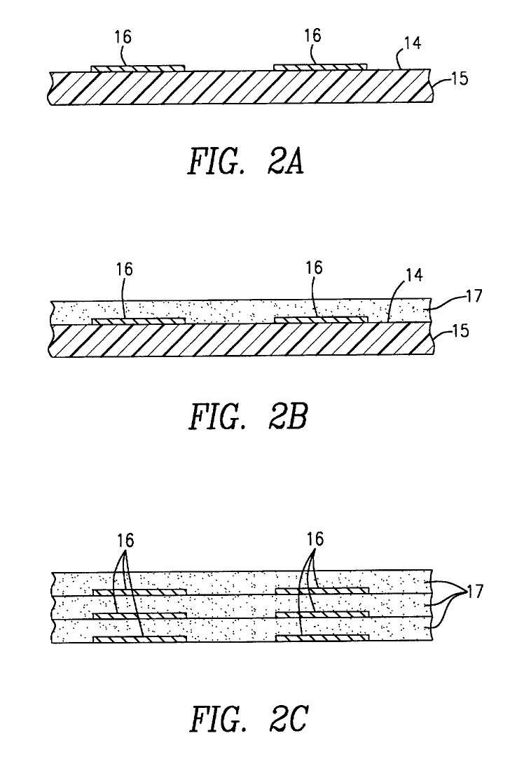

A metal film 16 to be used for an internal electrode 8 or 9 is formed on a support 15 having a flat surface 14 as shown in FIG. 2A for manufacturing the multilayer ceramic capacitor 1. The thickness of this metal film 16 is set in such a way that it is, for example, in the range of about 0.1 to 0.7 μm after the baking which will be described later.

As the above-described support 15, a synthetic resin film such as a polyethylene terephthalate (PET) film, or a film or a plate of other materials which has a shape-holding characteristic is used. The flat surface 14 of the support 15 on which the metal film 16 is formed is preferably subjected to surface release treatment using a fluororesin, a silicone resin, or the like.

The metal film 16 is composed of a nickel film, for example, and is preferably formed by a thin film forming method. As the thin film forming method, vapor deposition, sputtering or wet plating can be advantageously applied, for example. It is noted that a chemical vapor deposition method (CVD), ion plating or the like is also applicable as the thin film forming method.

When a metal film 16 made of nickel is formed by vapor deposition, the following process steps can be performed, specifically. That is, a nickel ingot or plate is melted by dielectric heating or with a heating means such as an electron beam, heating is continued until nickel vapor is generated, and the nickel vapor generated is deposited on a support 15 to form a metal film 16 made of nickel thin film.

When the metal film 16 made of nickel is manufactured by sputtering, a plasma is generated by glow discharging in an atmosphere comprising an inert gas such as an argon gas, a neon gas, or the like, and a nickel anode target is bombarded with argon ions generated in the vicinity of a cathode so as to emit superfine nickel particles, by which a metal film 16 made of nickel thin film can be formed on a support 15.

When plating is used for forming a metal film 16 made of nickel, a nickel film is formed on a support 15 by vapor deposition or by sputtering beforehand, and a metal film 16 made of nickel can be formed by immersing the support 15 into a plating bath containing nickel sulfate or nickel sulfamate as a main component, then supplying electric current to the nickel film on the support 15 so as to precipitate nickel from the plating liquid. It is noted that a brightener or other agents may be added to the plating bath, and the plating bath may be heated to 40° C. or more, as necessary, in order to prevent exfoliation of the nickel plating by the stresses at the time of precipitation.

After forming the metal film 16 in accordance with the above-described methods, the metal film 16 is subjected to patterning as the next step. A photolithographic technology can be applied to the patterning. That is, a method using a photosensitive resist and chemical etching, or a method in which a resist is pattern-printed, followed by chemical etching can be used to provide pattering to the metal film 16. FIG. 2A illustrates a metal film 16 after the patterning treatment.

A main raw material such as barium titanate, that is, a ceramic raw material powder as the starting ceramic material to be used for the ceramic layers 2, and additives to improve the properties or for other purposes are prepared.

Specified amounts of these ceramic raw material powder and additives are weighed, and they are subjected to wet mixing to produce a powder mixture. More specifically, each of the additive components is added by mixing them, in a form of an oxide powder or a carbonate powder, to the ceramic raw material powder, and the mixture is subjected to wet mixing. At that time, it is permissible to have each additive as a compound such as an alkoxide, an acetylacetonate or as a metallic soap, in order to make it soluble in an organic solvent. A method for adding solutions comprising each additive component to the surface of the ceramic raw material powder, followed by heat treatment or the like may be also possible.

Next, a ceramic slurry is prepared by adding an organic binder and solvent to the above-described powder mixture, and a ceramic green sheet to be used for the ceramic layers 2 is prepared by using this ceramic slurry. The thickness of the ceramic green sheet is preferably set in such a way that the thickness becomes about 3 μm or less after baking owing to the reasons that will be described later.

As shown in FIG. 2B, the above-described ceramic slurry is placed onto a support 15 so as to cover the metal film 16, by which a ceramic green sheet 17 is formed on the support 15.

Next, the surface of the ceramic green sheet 17 which is facing outward is subjected to compression/flattening treatment for reducing the surface roughness.

Regarding the surface roughness, it is preferable that the surface of the ceramic green sheet 17 has an arithmetic mean roughness (Ra) of about 100 nm or less. It is noted that the arithmetic mean roughness (Ra) is defined in Japanese Industrial Standard, JIS-B-0601.

While it is one of the measures for obtaining the above-described surface roughness of about 100 nm or less to improve the dispersibility of the powder material contained in the ceramic green sheet 17, it is particularly effective to apply compression/flattening treatment to the surface of the ceramic green sheet 17, instead of it or in addition to it. As a method for this compression/flattening treatment, a flat plate press method or a calender roll method can be applied, for example. In this compression/flattening treatment, it is also permissible to heat the ceramic green sheet 17, as necessary.

By subjecting the surface of the ceramic green sheet 17 to compression/flattening treatment, not only the surface of the ceramic green sheet 17 is made flatter, but also the distribution of the ceramic raw material powder in the ceramic green sheet 17 is made more uniform, and the density of the ceramic green sheet 17 is made more uniform, thus making it possible to advantageously suppress pore generation in the baking step which will be described later.

Also, when the arithmetic mean roughness (Ra) of the surface of the ceramic green sheet 17 is made to be about 100 nm or less by subjecting the surface to compression/flattening treatment, a multilayer ceramic capacitor 1 is formed in which the arithmetic mean roughness (Ra) of the interface between an internal electrode 8 or 9 and a ceramic layer 2 is made to be about 200 nm or less, it is effectively guaranteed that the area rate of pores in a cross-sectional area of the ceramic layers 2 is about 1% or less, and it is made possible without problems to make the thickness of the ceramic layers 2 as thin as about 3 μm or less, for example.

It is noted that when the arithmetic mean roughness (Ra) of the interface between an internal electrode 8 or 9, and a ceramic layer 2 is more than about 200 nm, or the area rate of pores is made to be more than about 1%, the life of the multilayer ceramic capacitor 1 will fall drastically.

Next, a plurality of the ceramic green sheets 17 integrated with the metal films 16 as described above, that is, those sheets holding the metal films 16, are laminated as shown in FIG. 2C, pressed, and then cut, as required. It is noted, though not shown in FIG. 2C, that, in the step of laminating the above-described ceramic green sheets 17, a requisite number of ceramic green sheets which do not hold metal films are usually laminated over and under the ceramic green sheets shown in the figure. Regarding the ceramic green sheets which are laminated thereover and thereunder, it is not necessary to subject their surfaces to compression/flattening treatment as described above as long as they do not contact with the metal films 16.

In this way, a laminated body 3 as shown in FIG. 1 is obtained in an unbaked state. Next, the unbaked laminated body 3 is baked in a reducing atmosphere, for example.

Next, a first external electrode 6 and a second external electrode 7 are formed on a first edge surface 4 and a second edge surface 5 of the laminated body 3, respectively, so that they are electrically connected to the exposed edges of the internal electrodes 8 of the first group and the internal electrodes 9 of the second group, respectively, in the baked laminated body 3.

There is no particular limitation to the material composition for the external electrodes 6 and 7. To be more specific, the same material as is used for the internal electrodes 8 and 9 can be used. Also, it can be constituted, for example, of a sintered layer of a variety of electroconductive metal powders such as Ag, Pd, Ag—Pd, Cu, and a Cu alloy, or of a sintered layer in which various glass frits of the B₂O₃—Li₂O—SiO₂—BaO type, B₂O_{3—SiO}₂—BaO type, Li₂O—SiO₂—BaO type, B₂O₃—SiO₂—ZnO type, etc., are compounded with the above-described electroconductive metal powders. Such a material composition for the external electrodes 6 and 7 is selected, as appropriate, in consideration of the application of the multilayer ceramic capacitor 1, the location in which it is to be used, or other conditions.

It is noted that the external electrodes 6 and 7 may be formed by applying a metal powder paste for the electrodes onto a laminated body 3 after baking, followed by baking, as described above. It is also possible to form them by applying the metal powder paste onto the laminated body 3 before baking, followed by baking it together with the laminated body 3, simultaneously.

After that, the external electrodes 6 and 7 are coated with plating layers 10 and 11 comprising Ni, Cu, a Ni—Cu alloy, or the like, respectively. Furthermore, second plating layers 12 and 13 comprising solder, tin, or the like are formed on these plating layers 10 and 11.

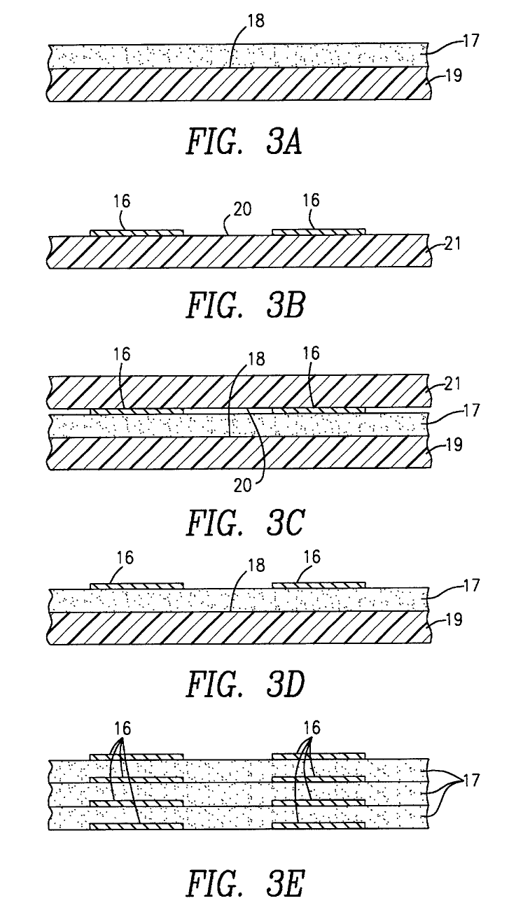

The method shown in FIGS. 3A to 3E may be employed for obtaining a laminated body 3 in an unbaked state. In FIGS. 3A to 3E, the same reference symbols are assigned to elements which correspond to the elements shown in FIGS. 2A to 2C, and the explanations which are the same as for FIGS. 2A to 2C are omitted for FIGS. 3A to 3E.

First, a ceramic green sheet 17 is formed on a first support 19 having a flat surface 18, as shown in FIG. 3A. Then the surface of the ceramic green sheet 17 which faces outward is subjected to compression/flattening treatment, so that the arithmetic mean roughness (Ra) of the surface is made to be about 100 nm or less. Substantially the same methods as in the embodiment explained with reference to FIGS. 2A to 2C can be employed for performing the step of forming the ceramic green sheet 17 and the step of its compression/flattening treatment.

In the meantime, a patterned metal film 16 is formed on a second support 21 having a flat surface 20 as shown in FIG. 3B. Regarding such steps of forming the metal film 16 and its patterning, substantially the same methods as in the embodiment explained with reference to FIGS. 2A to 2C can be employed.

Next, the metal film 16 is transferred from the second support 21 to the surface of the ceramic green sheet 17 which faces outward, as shown in FIGS. 3C and 3D. That is, the metal film 16 formed on the second support 21 is located so as to contact with the ceramic green sheet 17 as shown in FIG. 3C, pressure and heat are applied appropriately in this state, followed by peeling-off of the second support 21.

This will produce the metal film 16 in a state in which the film is held on the ceramic green sheet 17, as shown in FIG. 3D.

Next, a plurality of ceramic green sheets including a plurality of the ceramic green sheets 17 holding the metal films 16 are peeled off the first support 19 and are laminated as shown in FIG. 3E, pressed, and then cut, as required.

An unbaked laminated body 3 is obtained in this way. After that, the same 1 process steps are performed as in the embodiment explained with reference to FIGS. 2A to 2C, by which the subject multilayer ceramic capacitor 1 is obtained.

The embodiment explained above is about the case in which the laminated ceramic electronic part is a multilayer ceramic capacitor. This invention is also applicable to other laminated ceramic electronic parts such as a multilayer ceramic substrate that has substantially the same structure, for example.

As a metal constituting the metal film 16 which is to be used for the internal electrodes 8 and 9, a base metal such as a nickel alloy, copper, or a copper alloy as well as a precious metal such as silver or palladium may be used besides nickel which is described above. Furthermore, the metal film 16 may have a multilayer structure. For example, it may be a copper or silver film formed by vapor deposition or by sputtering, on which a nickel or palladium film is formed.

### EXAMPLE

Next, the present invention is explained in detail based on a more specific example. It is noted that embodiments which can be realized within the scope of the present invention are not limited to or by the example. For example, although only a barium titanate type dielectric ceramic is exemplified in the example, it has been confirmed that the same effects can also be obtained by using a dielectric ceramic having a perovskite structure which comprises, as the main component, strontium titanate, calcium titanate or the like.

The multilayer ceramic capacitor to be manufactured in the example is a multilayer ceramic capacitor 1 having a structure as shown in FIG. 1, which is to be manufactured according to the process steps as shown in FIGS. 2A to 2C.

1. Preparation of samples

First, a PET film was prepared for the support 15 as shown in FIGS. 2A to 2C. Next, metal films having thicknesses of 0.5 μm, 0.2 μm and 0.07 μm respectively, were formed on the PET film by a thin film forming method detailed below. It is noted that the thicknesses of 0.5 μm, 0.2 μm and 0.07 μm of these metal films correspond to the thicknesses of 0.7 μm, 0.3 μm and 0.1 μm of the internal electrodes after the lamination and baking steps, respectively, as shown in Table 1 which indicates the results of evaluations that will be described later.

More specifically, as the thin film forming method described above, vapor deposition and plating were employed. In the vapor deposition method, vapor deposition of nickel was effected by using a vapor deposition apparatus equipped with an ion beam to form a nickel film having a thickness of 0.03 μm. Next, at the plating step, nickel plating was performed on this nickel film having a thickness of 0.03 μm as a substrate and using a nickel sulfamate bath to form a nickel film by plating on the nickel film obtained by vapor deposition. Thus, a metal film was formed. The film thickness of this metal film was controlled by changing the electric current supply in the plating step.

Next, a photo resist was applied onto the metal film formed as described above, followed by the step in which part of the metal film was selectively etched using an aqueous cupric chloride solution according to the known photolithography technology, and the step of removing the remaining photoresist subsequently, in order to provide a patterning on the metal film.

In the meantime, a barium titanate (BaTiO₃) powder as a ceramic raw material powder was prepared by a hydrolysis method using tetraisopropoxytitanium and diethoxybarium as the starting raw materials. By baking this barium titanate powder at temperatures of 800° C., 875° C. and 950° C., respectively, barium titanate powders having average particle sizes of 98 nm, 153 nm and 210 nm were obtained as shown in Table 1, respectively.

Next, additives (including Dy+Mg+Mn as well as Si) were added to each of the above-described barium titanate powders in forms of oxide powders or carbonate powders, and mixed to prepare ceramic compositions.

Next, a polyvinylbutyral-based binder and ethanol as an organic solvent were added to the above-described barium titanate-derived ceramic composition powders, followed by wet-mixing with a ball mill to prepare ceramic slurries.

Next, for the purpose of obtaining such a structure as shown in FIG. 2B, ceramic green sheets were formed by supplying the above-described ceramic slurries onto the PET films having the metal films formed thereon which were patterned as described above, in such a way that the slurries covered the metal films, by the doctor blade method. At that time, the slit width of the doctor blade was regulated to form ceramic green sheets having thicknesses of 7.0 μm, 4.2 μm and 1.4 μm, respectively. It is noted that the thicknesses of 7.0 μm, 4.2 μm and 1.4 μm of the ceramic green sheets correspond to the thicknesses of 5 μm, 3 μm and 1 μm of the ceramic layers after the lamination and baking steps, respectively, as shown in Table 1.

The arithmetic mean roughnesses (Ra) of the surfaces of the ceramic green sheets described above were 228 nm when the average particle size of the barium titanate was 210 nm, 162 nm when the average particle size was 153 nm, and 120 nm when the average particle size was 98 nm, after the stage of the sheet forming step (corresponding to the cases of “No” pressing in Table 1). Furthermore, when compression/flattening was performed onto these ceramic green sheets with a flat plate press (500 kg/cm²) (corresponding to the cases of “Yes” pressing in Table 1), the values of surface roughness (Ra) decreased from 228 nm to 143 nm, from 162 nm to 97 nm, and from 120 nm to 48 nm, respectively, by which the first values, 228, 162 nm and 120 nm were those obtained at the stage just after the sheet forming step.

It is noted that the surface roughnesses (Ra) of the above-described ceramic green sheets were determined from the values measured from an area of 20 mm by 20 mm using an interatomic force microscope.

Next, the above-described ceramic green sheets were peeled off the PET films, and a plurality of them were laminated in such a way that the sides on which metal films were held were located on either side of the laminated body in an alternate manner, and heat-pressed for integration. Then, the integrated laminated structure was cut to a specific size, and an unbaked laminated body or an unbaked chip was obtained. This unbaked chip was heated in a nitrogen atmosphere at a temperature of 300° C. to burn the binder, and then it was baked with a profile in which it was held in a reductive atmosphere comprising H₂—N₂—H₂O gas at an oxygen partial pressure of from 10⁻⁹ to 10⁻¹² MPa at 1,200° C. for 2 hours.

Next, a silver paste comprising a B₂O₃—Li₂O—SiO₂—BaO type glass frit was applied to both edge surfaces of the laminated body after baking, followed by baking it in a nitrogen atmosphere at a temperature of 600° C. so as to form external electrodes which were electrically connected to the internal electrodes.

The outer dimensions of the multilayer ceramic capacitor thus obtained were 5.0 mm in width, 5.7 mm in length and 2.4 mm in thickness. The overall number of the effective dielectric ceramic layers was 5. The area in which two electrodes faced each other was 16.3×10⁻⁶ m² per layer.

2. Evaluation of the samples

Next, various structural and electrical properties were evaluated for each of these sample multilayer ceramic capacitors thus obtained by the following procedures. The results of these evaluations are shown in Table 1.

In Table 1, “ceramic layer thickness”, “internal electrode thickness”, arithmetic mean roughness (Ra) of the interfaces between internal electrodes and ceramic layers, that is, “interfacial roughness”, area rate of pores in a cross-sectional area of ceramic layers, that is, “area rate of pores”, and coated area rate of internal electrodes, that is, “internal electrode coverage” regarding a multilayer ceramic capacitor were respectively determined by performing image analysis of a picture obtained in the observation of a polished cross-sectional area of a multilayer ceramic capacitor with a scanning electron microscope.

Furthermore, capacitance as well as dielectric loss or “tan δ” shown in Table 1 was measured according to JIS standard 5102 using an automatic bridge type measuring instrument, and the dielectric constant or “∈ᵣ” was calculated from the measured capacitance value.

Also, a high temperature loading test was performed for measuring the change of insulation resistance with the passage of time while loading a direct current electric field of 10 V/mm at a temperature of 150° C., and the average time until the failure or “mean life” was obtained, in which the failure was defined as the time when the insulation resistance value became 10⁵ Ω or less for each sample.

TABLE 1

| | | Green sheet | | | | Ceramic | Internal | Internal | | | |
|---|---|---|---|---|---|---|---|---|---|---|---|
| | BaTiO₃ | surface | | Interfacial | Area rate | layer | electrode | electrode | Electric properties | | |
| Sample | particle size | roughness | | roughness | of pores | thickness | thickness | coverage | | tan δ | Mean life |
| No. | (nm) | (nm) | Pressing | (nm) | (%) | (μm) | (μm) | (%) | εᵣ | (%) | (Hr) |
| *1 | 210 | 228 | No | 250 | 3 | 3 | 0.7 | 95 | 1640 | 2.4 | 1 |
| *2 | 210 | 143 | Yes | 210 | 1.5 | 3 | 0.7 | 97 | 1600 | 2.4 | 10 |
| *3 | 153 | 162 | No | 220 | 2 | 3 | 0.7 | 90 | 1450 | 2.4 | 3 |
| 4 | 153 | 97 | Yes | 110 | 0.7 | 3 | 0.7 | 93 | 1420 | 2.4 | 59 |
| 5 | 98 | 120 | No | 150 | 0.8 | 3 | 0.7 | 92 | 1270 | 2.4 | 40 |
| 6 | 98 | 48 | Yes | 60 | 0.5 | 3 | 0.7 | 94 | 1250 | 2.4 | 72 |
| *7 | 153 | 162 | No | 250 | 2.8 | 3 | 0.3 | 85 | 1470 | 2.6 | 4 |
| 8 | 153 | 97 | Yes | 130 | 0.8 | 3 | 0.3 | 83 | 1430 | 2.6 | 55 |
| 9 | 98 | 120 | No | 180 | 0.8 | 3 | 0.3 | 82 | 1240 | 2.6 | 35 |
| 10 | 98 | 48 | Yes | 80 | 0.5 | 3 | 0.3 | 84 | 1260 | 2.6 | 75 |
| *11 | 153 | 162 | No | 280 | 2.9 | 3 | 0.1 | 80 | 1420 | 2.8 | 5 |
| 12 | 153 | 97 | Yes | 140 | 0.8 | 3 | 0.1 | 75 | 1440 | 2.8 | 55 |
| *13 | 98 | 120 | No | 210 | 1.5 | 3 | 0.1 | 74 | 1250 | 2.8 | 3 |
| 14 | 98 | 48 | Yes | 90 | 0.5 | 3 | 0.1 | 75 | 1230 | 2.9 | 70 |
| *15 | 210 | 228 | No | 300 | 3 | 5 | 0.3 | 50 | 1250 | 2.6 | 8 |
| 16 | 210 | 143 | Yes | 190 | 1 | 5 | 0.3 | 79 | 1630 | 2.6 | 71 |
| *17 | 153 | 162 | No | 210 | 1.5 | 5 | 0.3 | 78 | 1450 | 2.6 | 10 |
| 18 | 153 | 97 | Yes | 130 | 0.5 | 5 | 0.3 | 81 | 1440 | 2.6 | 120 |
| *19 | 210 | 228 | No | 240 | 3 | 1 | 0.3 | 84 | 1590 | 2.8 | 8 |
| 20 | 210 | 143 | Yes | 150 | 1 | 1 | 0.3 | 80 | 1600 | 2.8 | 40 |
| 21 | 153 | 162 | No | 170 | 0.8 | 1 | 0.3 | 76 | 1390 | 2.8 | 45 |
| 22 | 153 | 97 | Yes | 100 | 0.5 | 1 | 0.3 | 75 | 1380 | 2.8 | 56 |

In Table 1, the samples with asterisked sample numbers are out of the range ofthe present invention. That is, samples 1, 2, 3, 7, 11, 13, 15, 17 and 19 have all “interfacial roughnesses” in excess of about 200 nm. Their “area rates of pores” also exceed about 1%. As a result, the “mean lives” are short. It is noted that the “green sheet surface roughnesses” of these samples all exceed about 100 nm.

In contrast, samples 4 to 6, 8 to 10, 12, 14, 16, 18 and 20 to 22 which are within the range of the present invention have “interfacial roughnesses” of about 200 nm or less and “area rates of pores” of about 1% or less. As a result, the “mean lives” are longer.

The following are further considerations on particular samples.

Sample 2, which was obtained by subjecting the surface of a ceramic green sheet to compression/flattening treatment, has a “green sheet surface roughness” of 143 nm which is more than about 100 nm, an “interfacial roughness” of more than about 200 nm, and an “area rate of pores” of more than about 1%, thus resulting in a shorter “mean life”.

When comparison is made among samples 4 to 6, 8 to 10, 12 and 14 that are within the scope of the present invention, the “green sheet surface roughnesses” are 120 nm for samples 5 and 9, 97 nm for samples 4, 8, and 12, and 48 nm for samples 6, 10 and 14. That is, “the green sheet surface roughnesses” decrease in the order of the above-described enumeration. Consequently, the more the “green sheet surface roughness” is decreased, the more the “interfacial roughness” is decreased, and the smaller the “area rate of pores” becomes, showing a trend toward a further improved “mean life”. Particularly, with samples 6, 10 and 14 which have “green sheet surface roughnesses” of 48 nm, the “interfacial roughnesses” are 100 nm or less, and the “area rates of pores” are 0.5%, with improved “mean lives” of 70 hours or more.

With samples 15 to 18, the “ceramic layer thicknesses” are 5 μm. With samples 19 to 22, the “ceramic layer thicknesses” are 1 μm. The reliability is closely related with the ceramic layer thickness and the number of grains in a unit thickness, and, in general, the reliability becomes the higher, the thicker is the ceramic layer, and the larger is the number of grains. This trend is observed in the comparison of “mean lives” between samples 15 to 18 and samples 19 to 22.

On the other hand, based on the dimensional restrictions required for a multilayer ceramic capacitor, the thicker a ceramic layer is, the less advantageous it is to realize a larger number of the layers (a higher capacitance). However, it is understood that even with the samples having ceramic layer thicknesses of about 3 μm or less, especially with samples 19 to 22 that have ceramic layer thicknesses of 1 μm, the “mean life” can be made longer when the “interfacial roughness” is made to be about 200 nm or less, and the “area rate of pores” is made to be about 1% or less, as shown in the cases of samples 20 to 22.

As described above, according to the present invention, a laminated ceramic electronic part having a long mean life and an excellent reliability can be obtained even when the thicknesses of the ceramic layers are about 3 μm or less, since the arithmetic mean roughness (Ra) of the interfaces between the internal electrodes and the ceramic layers is made to be about 200 nm or less, and the area rate of pores in a cross-sectional area of the ceramic layers is made to be about 1% or less. When the present invention is applied to a multilayer ceramic capacitor, it is extremely effective in realizing a smaller multilayer ceramic capacitor with a larger capacitance.

In order to realize such an interfacial flatness as described above, it is effective to make about 100 nm or less the arithmetic mean roughness (Ra) of the surface of the ceramic green sheet for forming the ceramic layers, and to use metal films formed by a thin film forming method as the internal electrodes. Furthermore, since vapor deposition, sputtering or plating can be applied as the thin film forming method without any problem, it is possible to execute the steps of forming the internal electrodes efficiently.

What is claimed is:

1. A method for manufacturing a laminated ceramic comprising:
providing a ceramic green sheet having side edges and comprising a ceramic raw material and subjecting a surface of said ceramic green sheet to a compression/flattening treatment until said surface has an arithmetic mean roughness (Ra) of about 100 nm or less;
before or after said compression/flattening treatment, providing a metallic layer on a portion of one surface of said ceramic green sheet; and
after said compression/flattening treatment, baking the compressed/flattened ceramic green sheet-metallic layer composite.

2. A method according claim 1, wherein said ceramic green sheet has a thicknesses after said compression/flattening treatment of about 3 mm or less.

3. A method according to claim 2 further comprising laminating a plurality of compressed/flattened ceramic green sheet-metallic layer composites before said baking.

4. A method according to claim 3 wherein said ceramic comprises a ceramic dielectric, said metallic layer is disposed so as to extend inwardly from one side edge of said ceramic green sheet, and wherein said plurality of compressed/ flattened ceramic green sheet-metallic layer composites are laminated such that a sequentially adjacent pair of metallic layers extend inwardly from different side edges of the resulting laminate.

5. A method according to claim 4 further comprising providing at least two electrodes external to the laminate, each of which is electrically connected to a different one of said pair of metallic layers, whereby a multilayer ceramic capacitor is constructed.

6. A method according to claim 1 further comprising laminating a plurality of compressed/flattened ceramic green sheet-metallic layer composites before said baking.

7. A method according to claim 6 wherein said ceramic comprises a ceramic dielectric, said metallic layer is disposed so as to extend inwardly from one side edge of said ceramic green sheet, and wherein said plurality of compressed/flattened ceramic green sheet-metallic layer composites are laminated such that a sequentially adjacent pair of metallic layers extend inwardly from different side edges of the resulting laminate.

8. A method according to claim 7 further comprising providing at least two electrode external to the laminate, each of which is electrically connected to a different one of said pair of metallic layers, whereby a multilayer ceramic capacitor is constructed.

9. A method for manufacturing a laminated ceramic electronic part according to claim 1, comprising:
forming a metal film to be used for an internal electrode on a support having a flat surface;
forming a ceramic green sheet comprising a ceramic raw material powder over said support so as to cover said metal film;
subjecting a surface of said ceramic green sheet facing away from the metal film to a compression/flattening treatment until said surface has an arithmetic mean roughness (Ra) of about 100 nm or less;
separating said ceramic green sheet and metal film combination from said support;
obtaining an unbaked laminated body by laminating a plurality of ceramic green sheets including said separated ceramic green sheet and metal film combination; and
baking said unbaked laminated body.

10. A method for manufacturing a laminated ceramic electronic part according to claim 9, wherein said forming a metal film comprises thin film forming.

11. A method for manufacturing a laminated ceramic electronic part according to claim 10, wherein said thin film forming is vapor deposition, sputtering or plating.

12. A method for manufacturing a laminated ceramic electronic part according to claim 9, wherein said ceramic green sheet is subjected to said compression/flattening treatment until the thickness of the green sheet is about 3 mm or less.

13. A method for manufacturing a laminated ceramic electronic part according to claim 12 wherein said ceramic comprises a ceramic dielectric, said metallic layer is disposed so as to extend inwardly from one side edge of said ceramic green sheet, and wherein said plurality of ceramic green sheets including said separated ceramic green sheet and metal film combination are laminated such that a sequentially adjacent pair of metallic layers extend inwardly from different side edges of the resulting laminate.

14. A method for manufacturing a laminated ceramic electronic part according to claim 1 comprising:
forming a ceramic green sheet comprising a ceramic raw material powder on a first support having a flat surface;
subjecting a surface of said ceramic green sheet facing away from said first support to compression/flattening treatment until said surface has an arithmetic mean roughness (Ra) of about 100 nm or less;
forming a metal film to be used for an internal electrode on a second support having a flat surface;
transferring said metal film from said second support onto the surface of said ceramic green sheet facing away from said first support;
separating said ceramic green sheet and metal film combination from said ceramic green sheet support;
obtaining an unbaked laminated body by laminating a plurality of ceramic green sheets including said ceramic green sheet and metal film combination; and
baking said unbaked laminated body.

15. A method for manufacturing a laminated ceramic electronic part according to claim 14, wherein said forming a metal film comprises thin film forming.

16. A method for manufacturing a laminated ceramic electronic part according to claim 15, wherein said thin film forming is vapor deposition, sputtering or plating.

17. A method for manufacturing a laminated ceramic electronic part according to claim 14, wherein said ceramic green sheet is subjected to said compression/flattening treatment until the thickness of the green sheet is about 3 mm or less.

18. A method for manufacturing a laminated ceramic electronic part according to claim 17 wherein said ceramic comprises a ceramic dielectric, said metallic layer is disposed so as to extend inwardly from one side edge of said ceramic green sheet, and wherein said plurality of ceramic green sheets including said separated ceramic green sheet and metal film combination are laminated such that a sequentially adjacent pair of metallic layers extend inwardly from different side edges of the resulting laminate.
